(19) United States
(12) Patent Application Publication
(10) Pub. No.: US 2006/0256068 A1
(43) Pub. Date: Nov. 16, 2006

(54) PORTABLE ELECTRONIC DEVICE AND DISPLAY SYSTEM USING THE SAME

(76) Inventor: Yasushi Narushige, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/382,829

(22) Filed: May 11, 2006

(30) Foreign Application Priority Data
May 12, 2005 (JP) 2005-139781

(51) Int. Cl. G09G 3/36

(52) U.S. Cl. 345/102

(57) ABSTRACT

A cell phone includes a body having an opening, a display panel which closes the opening and displays an image, and a backlight unit. The backlight unit is movable between a display position in which it faces the display panel to close the opening and applies illumination light to the display panel and an open position in which the backlight unit is situated off the opening. A projector includes a housing having a loading slot into which the display panel of the portable electronic device is insertable, a light source section, and an optical system which diffuses and outwardly radiates illumination light applied from the light source section. The portable electronic device is to be loaded into the loading slot with the backlight unit moved to the open position, and the display panel is located across an optical axis of the optical system at right angles thereto.

### CROSS-REFERENCE TO RELATED APPLICATIONS

This application is based upon and claims the benefit of priority from prior Japanese Patent Application No. 2005-139781, filed May 12, 2005, the entire contents of which are incorporated herein by reference.

### BACKGROUND OF THE INVENTION

1. Field of the Invention

The present invention relates to a portable electronic device with a display section, such as a cell phone, mobile terminal, etc., and a display system using the same.

2. Description of the Related Art

In recent years, small-sized portable electronic devices, such as cell phones, personal digital assistants (PDAs), etc., have become widely popular. For example, a conventional cell phone comprises a display, which is formed of a liquid crystal display panel, a plurality of input keys, etc. Further, the cell phone has various functions, such as electronic mail transfer, photographing, movie playback, music playback, TV image playback, etc., as well as a call function. Mail documents, movies, TV images, etc. are displayed on a display and observed by a user. Usually, the display that is formed of a liquid crystal display panel has a narrow angular field of view, and its screen size is small. It is hard for two or more people, therefore, to watch character information, an image, etc. on the display simultaneously.

Recently, there has been proposed a cell phone that is furnished with a removable projector such that a large number of people can observe information displayed on its display (e.g., Jpn. Pat. Appln. KOKAI Publication No. 2005-51600). The projector is set independently of a body of the cell phone or removably mounted in place of the display when it projects an image on the display onto an external object. The projector shares its light source with the display.

In the cell phone with the removable projector constructed in this manner, the light source of the display is also used as that of the projector. As described above, however, the display of the cell phone is relatively small in size, and its light source is also small and can produce only a small amount of light. Since the projector itself is also small-sized, moreover, it is not easy to secure a large enough optical system including a projection lens and the like. In projecting images by the projector, therefore, it is difficult to display high-resolution images with satisfactory luminance that are large enough to be simultaneously observed by a large number of people. It is difficult, in particular, to clearly display moving images, such as TV images.

### BRIEF SUMMARY OF THE INVENTION

This invention has been made in consideration of these circumstances, and its object is to provide a portable electronic device, configured so that a number of people can watch an enlarged image displayed on its display panel, and a display system using the same.

In order to achieve the above object, a portable electronic device according to an aspect of the invention comprises: a body having an opening; a display panel which closes the opening and displays an image; and a backlight unit movable between a display position in which the backlight unit faces the display panel in the body, is situated closing the opening and applies illumination light to the display panel and an open position in which the backlight unit is situated off the opening and allows a back side of the display panel to open.

A display system according to another aspect of the invention comprises: a portable electronic device comprising a body having an opening, a display panel which closes the opening and displays an image, and a backlight unit movable between a display position in which the backlight unit faces the display panel in the body, is situated closing the opening and applies illumination light to the display panel and an open position in which the backlight unit is situated off the opening and allows a back side of the display panel to open; and a projector comprising a housing having a loading slot into which at least the display panel of the portable electronic device is insertable, a light source section located in the housing, and an optical system which is located in the housing and diffuses and outwardly radiates illumination light applied from the light source section, the portable electronic device being configured to be loaded into the loading slot with the backlight unit moved to the open position, the display panel being located across an optical axis of the optical system at right angles thereto.

Thus, according to the above-mentioned structure, there may be provided a portable electronic device, configured so that a number of people can observe an enlarged image displayed on its display panel, and a display system using the same.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a display system according to an embodiment of the invention;

FIG. 2 is an exploded perspective view showing a projector and a cell phone of the display system;

FIG. 3 is a perspective view showing the cell phone;

FIG. 4 is a perspective view showing the cell phone with its backlight unit drawn out to an open position;

FIG. 5 is a sectional view of the cell phone taken along line V-V of FIG. 3;

FIG. 6 is a sectional view showing the backlight unit of the cell phone;

FIG. 7 is a diagram schematically showing a liquid crystal display panel and a control circuit section of the cell phone; and

FIG. 8 is a sectional view of the display system taken along line VIII-VIII of FIG. 1.

### DETAILED DESCRIPTION OF THE INVENTION

A display system according to an embodiment of the present invention will now be described in detail with reference to the accompanying drawings.

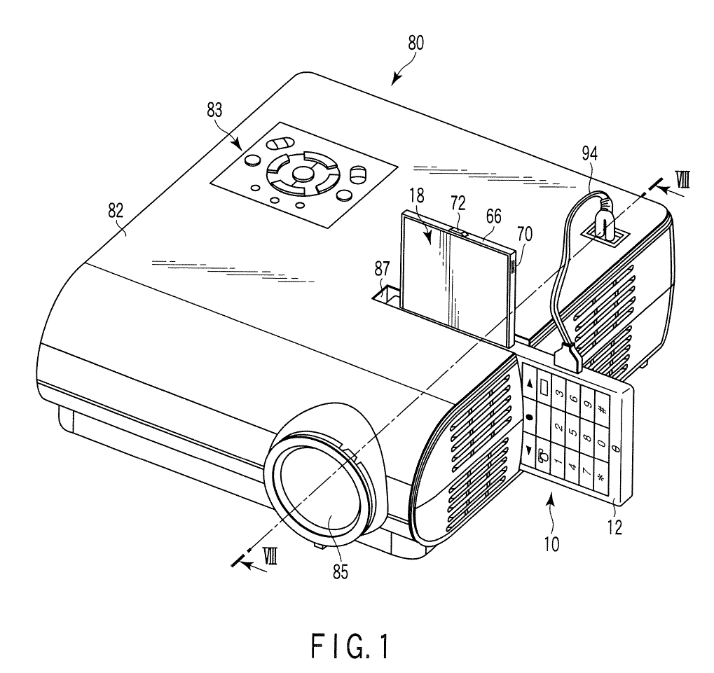

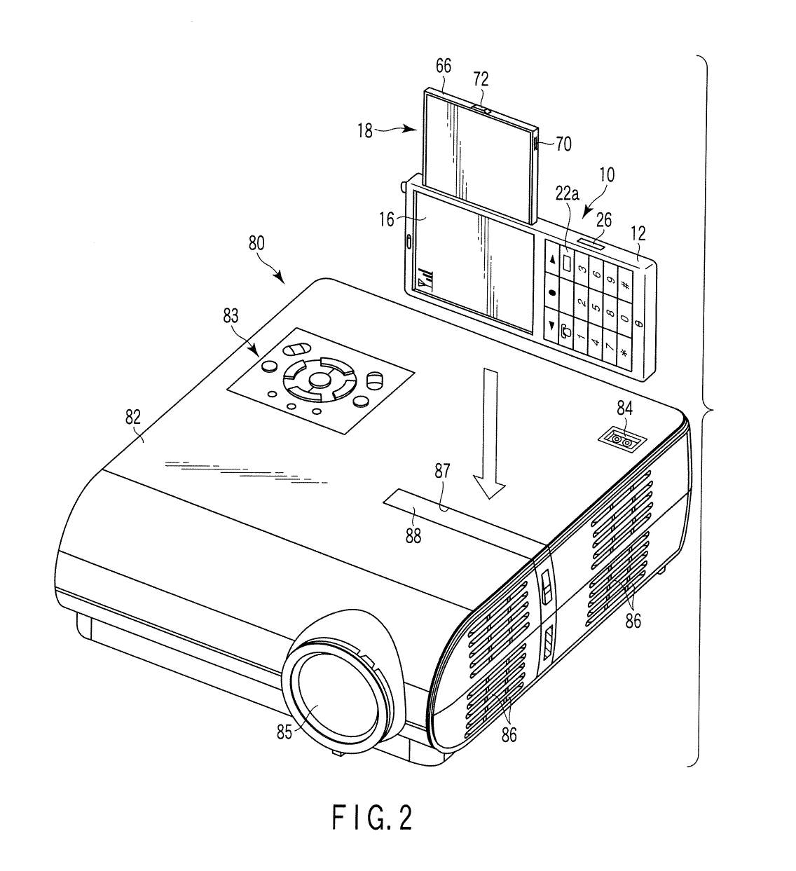

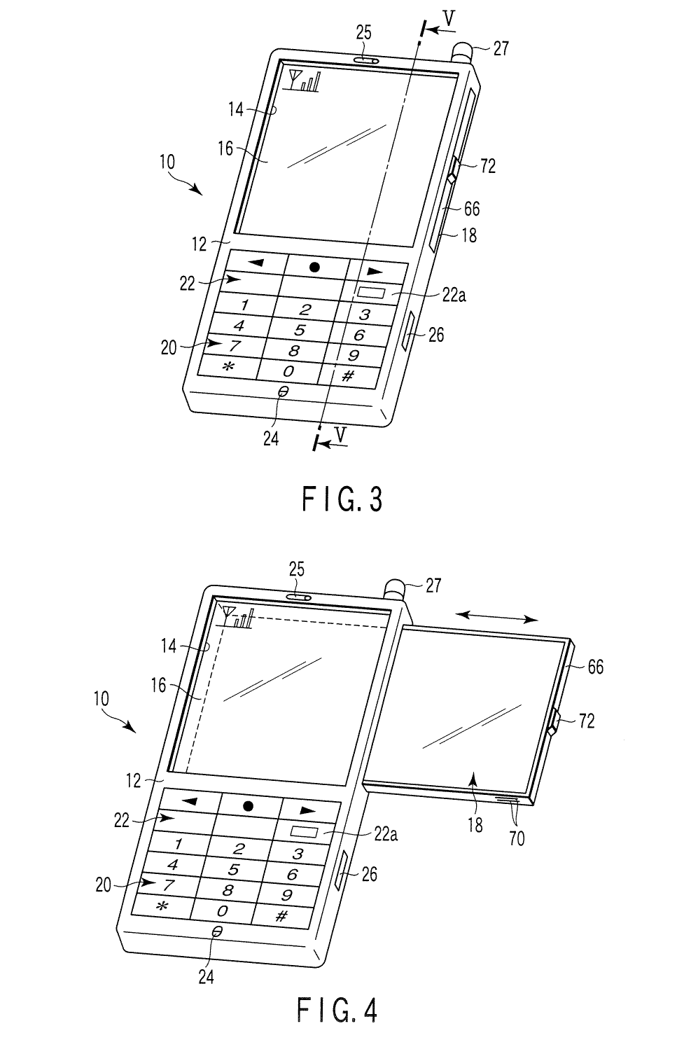

FIGS. 1 and 2 show the whole image of the display system, while FIGS. 3 to 7 show a cell phone as a portable electronic device used in the display system.

As shown in FIGS. 1 and 2, the display system comprises a cell phone 10 and a projector 80 that projects an image displayed on a display panel of the cell phone to the outside. The cell phone 10 will first be described in detail.

As shown in FIGS. 3 and 4, the cell phone 10 is provided with a body 12 in the form of a flat rectangular box. A rectangular opening 14 is formed covering about half the area of the body 12. The opening 14 is formed penetrating the body 12 and opens in the front and back of the body. A light-transmitting display panel 16 (mentioned later) is located in the body 12 so as to close the opening 14, and its greater part is exposed through the opening 14 to the front side of the body. A backlight unit 18 in the form of rectangular plate is located in the body 12. As mentioned later, the backlight unit 18 is movable between a display position in which it is situated closing the opening 14 and faces the display panel 16 and an open position in which it is drawn out of the body 12 and allows the opening 14 to open.

Numeric keys 20 and control keys 22 are disposed on the front face of the body 12. The control keys 22 include a reversal key 22a for reversing the relative position of the displayed image. A microphone, a speaker, etc. (not shown) are arranged in the body 12. A port 24 that faces the microphone is formed in a lower part of the front face of the body 12, and a port 25 that faces the speaker in a lower part. An audio output terminal 26 is provided on a side face of the body 12. A telescopic antenna 27 is provided on the upper end portion of the body 12.

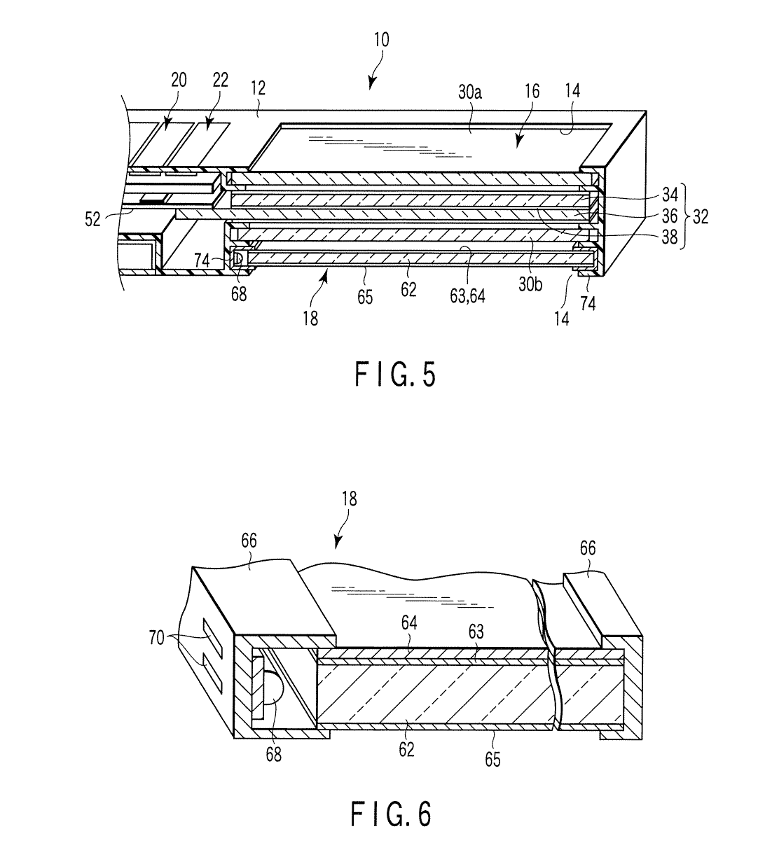

As shown in FIG. 5, two transparent cover plates 30a and 30b made of glass are arranged in the body 12 so as to close the opening 14. The cover plate 30a is situated closest to the front face of the body 12 and exposed through the opening 14 to the outside. The cover plate 30b is situated substantially in the center of the body 12 with respect to its thickness direction and faces the cover plate 30a with a gap between them.

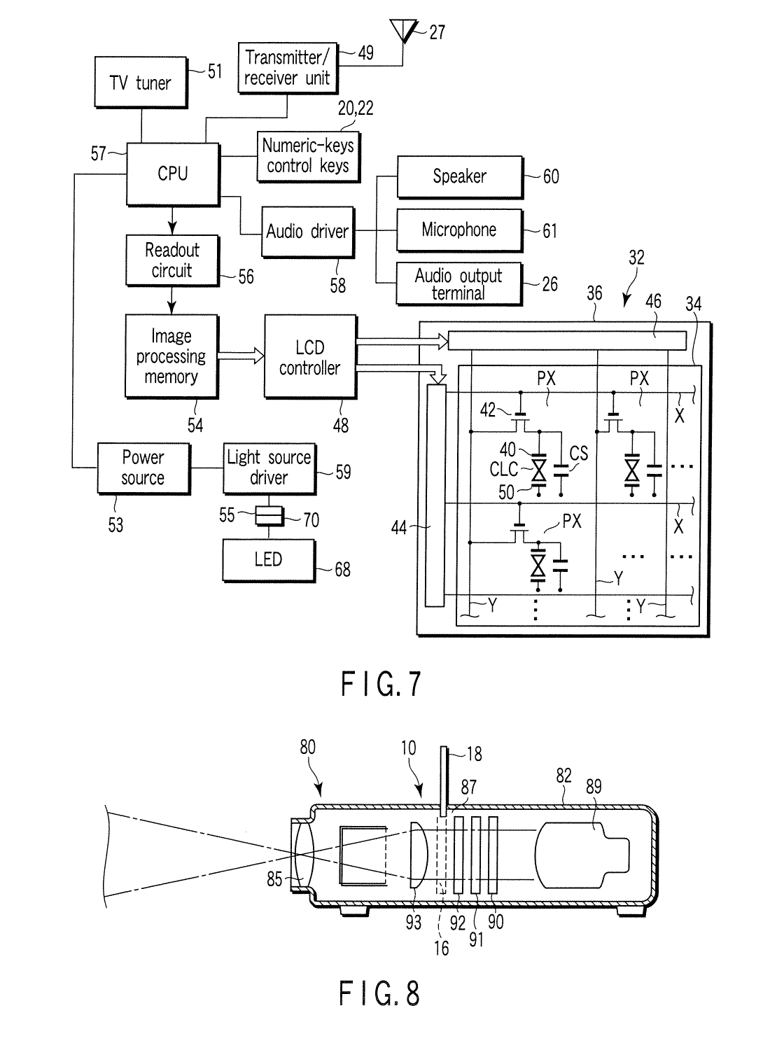

A liquid crystal display panel 32 that constitutes the display panel 16 is located between the cover plates 30a and 30b so as to close the opening 14. As shown in FIGS. 5 and 7, the display panel 32 has an array substrate 36, an opposite substrate 34 opposed to the array substrate with a gap between them, and a liquid crystal layer 38 held between these substrates with orientation films between them. The array substrate 36 and the opposite substrate 34 have their respective rectangular shapes. The array substrate 36 is formed larger than the opposite substrate 34, and a part of its peripheral edge extends beyond the opposite substrate.

The liquid crystal display panel 32 has (m×n) number of display pixels PX that are arranged in a matrix to form a display region. The array substrate 36 is formed of a transparent insulating substrate. Provided on one principal surface (obverse) of the array substrate 36 are (m×n) number of pixel electrodes 40, n number of scanning lines X, m number of signal lines Y, switch elements 42, auxiliary capacitors CS, etc. The pixel electrodes 40 are arranged in a matrix corresponding to the individual display pixels PX. The scanning lines X extend along each column of the pixel electrodes. Each switch element 42 is composed of a thin film transistor (TFT) that is connected close to a cross section between a scanning line X and a signal line Y. The auxiliary capacitors CS are connected in parallel with a cholesteric liquid crystal capacitance CLC (liquid crystal layer 38). The liquid crystal display panel 32 has, for example, a VGA-standard resolution and is provided with 680×480 pixel electrodes 40 for each of colors R, G and B.

A scanning line driver 44 connected to a plurality of scanning lines X and a signal line driver 46 connected to a plurality of signal lines Y are formed outside the display on the array substrate 34. Each of the drivers 44 and 46, like each switch element 42 in the display region, is formed of a thin film transistor that includes a polysilicon film as a semiconductor material. The scanning line driver 44 successively supplies scanning signals (driving signals) to the n number of scanning lines X under the control by an LCD controller 48. The signal line driver 46 successively supplies video signals (driving signals) to the m number of signal lines Y. In each scanning time, the switch elements 42 corresponding to the selected scanning line by the scanning signals under the control of an LCD controller 48 are turned on. Thus, the pixel electrodes 40 corresponding to the selected scanning line are adjusted to a pixel potential corresponding to a video signal that is supplied through is corresponding switch element 42.

The opposite substrate 34 is formed of a transparent insulating substrate, and a color filter (not shown), opposite electrodes 50, and the orientation films are successively stacked in layers on one principal surface (obverse) thereof. The opposite electrodes 50 are formed covering the entire effective region and face the pixel electrodes 40, individually. Each of the electrodes 40 and 50 is formed of a transparent conductive film of indium tin oxide (ITO) or the like.

The array substrate 36 and the opposite substrate 34 have their respective peripheral edge portions pasted together with a seal. A predetermined gap, e.g., a gap of 4 μm, is defined between these substrates by spacers. The liquid crystal layer 38, which can display in, for example, an OCB type, is sealed between the array substrate 36 and the opposite substrate 34. In the liquid crystal display panel 32, polarizers (not shown) are provided individually on the respective outer surfaces of the substrates 34 and 36. The directions of polarization of the sheet polarizers are set in accordance with the properties of the liquid crystal layer 38.

As shown in FIGS. 5 and 7, a control circuit board 52 is connected to the array substrate 36 of the display panel 32. The circuit board 52 is mounted with the LCD controller 48, an image processing memory 54, and a readout circuit 56, a CPU 57, an audio driver 58, a light source driver 59, etc. The CPU 57 serves as a control section that controls the whole cell phone 10. The control circuit board 52 extends from the display panel 32 and is located in the body 12 so as to underlie the numeric keys 20 and the control keys 22. The CPU 57 is connected with the numeric keys 20 and the control keys 22 that include the reversal key 22a (see FIG. 3). The audio driver 58 is connected with a speaker 60, a microphone 61, and the audio output terminal 26. Further, the cell phone 10 is provided with a built-in power source 53 in the body 12, connection terminals 55 connected to the light source driver 59, a TV tuner 51, a transmitter-receiver unit 49, etc.

As shown in FIGS. 4 and 6, the backlight unit 18 is constructed as a surface light source unit, which includes an acrylic, rectangular light guide plate 62, optical sheet such as diffusion sheet 63, lens sheet 64, and reflection sheet 65. The diffusion sheet 63 and the lens sheet 64 are successively stacked in layers on one principal surface of the light guide plate. The reflection sheet 65 is put on the other principal surface of the light guide plate. The respective peripheral edge portions of the light guide plate 62 and the optical sheets are held in place by a rectangular support frame 66.

The backlight unit 18 has a plurality of LEDs 68 as light sources that are opposed to one side face of the light guide plate 62. The LEDs 68 are fixed to the inner surface side of the support frame 66. Power terminals 70 are provided on the front end portion of one sidewall of the support frame 66 and connected electrically to the LEDs 68. A knob 72 used to slide the backlight unit 18 protrudes from the other sidewall of the support frame 66, which extends parallel to the side face of the body 12 in this case.

The body 12 has a pair of guide grooves 74 that extend in the transverse direction of the body along the peripheral edge of the opening 14. The guide grooves 74 constitute a guide portion of the body 12. The backlight unit 18 is held in the body 12 when a pair of side edge portions of the support frame 66 are inserted in the guide grooves 74, individually. The backlight unit 18 is supported for movement along the guide grooves 74 between the display position shown in FIG. 3 and the open position shown in FIG. 4. In the display position, as shown in FIGS. 3 and 5, the backlight unit 18 is situated so as to close the opening 14 and face the display panel 16. As shown in FIG. 7, moreover, the power terminals 70 on the support frame 66 conduct with the connection terminals 55 on the side of the body 12 and are connected to the power source 53. When the LEDs 68 of the backlight unit 18 are lit by the power source 53 and the light source driver 59, illumination light is emitted from the light guide plate 62 toward the liquid crystal display panel 32. Thus, an image including characters, a movie, etc. is displayed through the display panel 32.

In the open position, as shown in FIG. 4, the greater part of the backlight unit 18 is drawn out sideways from the body 12 and exposed to the outside. On the back side of the body 12, therefore, the opening 14 is opened so that the back side of the liquid crystal display panel 32 opens to the outside of the body through the opening 14. As the backlight unit 18 moves to the open position, the power terminals 70 of the support frame 66 leave the connection terminals 55 of the body 12, whereupon power supply to the LEDs 68 are cut off automatically.

In moving the backlight unit 18 to the open position, the knob 72 that protrudes from the support frame 66 can be drawn out of the body 12. The backlight unit 18 is held in the display position or the open position by a click mechanism (not shown), whereby it is prevented from moving unexpectedly and from slipping out of the body 12.

When a user singly uses the cell phone 10 constructed in this manner as a conventional cell phone to perform electronic mail transmission-reception, image display, etc., the backlight unit 18 is moved to the display position to facilitate the image display. If two or more people are to observe an image displayed on the display panel 16, as described later, the backlight unit 18 may be drawn out into the open position.

As shown in FIGS. 1, 2 and 8, the projector 80 comprises a housing 82 in the form of a rectangular box. Provided on the top surface of the housing 82 are a control panel 83 having various control keys and an audio input terminal 84 for audio input. A projection lens 85 is located exposed on the front face of the housing 82, while a number of vent holes 86 for heat radiation are formed in a side face of the housing. The housing 82 is formed having a loading slot 87 into which the cell phone 10 can be inserted. The slot 87 continuously opens on the top surface and the side face of the housing 82. When it is not loaded with the cell phone 10, the loading slot 87 is closed by a removable cover 88.

As shown in FIG. 8, a light source section 89 and various optical system units are arranged in the housing 82. The light source section 89 has a discharge lamp and a lamp reflector. The optical system units are situated between the light source section and the projection lens 85. The optical system units include an ultraviolet and infrared radiation cut filter 90, fly-eye lens 91, PS separation-synthesis section 92, converging lens 93, etc., which are arranged along the optical axis of the light source section 89. The filter 90 serves to remove unnecessary ultraviolet and infrared rays from illumination light that is emitted from the light source section 89. The fly-eye lens 91 is formed by assembling a plurality of small lenses. It uniformly condenses the illumination light without a loss and guides it to the PS separation-synthesis section 92. The illumination light that is passed through the section 92 is converged by the converging lens 93 and projected onto an external screen, wall surface, or the like through the projection lens 85.

The loading slot 87 is situated on the optical axis of the illumination light between the PS separation-synthesis section 92 and the converging lens 93. Further, the slot 87 extends at right angles to the optical axis of the illumination light. The slot 87 has a width, depth, and other dimensions such that it can receive and hold the cell phone 10 inserted therein.

In displaying an image using the cell phone 10 and the projector 80, the backlight unit 18 of the cell phone is first drawn out of the body 12 and moved to the open position, as shown in FIGS. 1, 2 and 8, with the image, e.g., a TV image, displayed on the display panel 16. As this is done, the back side of the liquid crystal display panel 32 is exposed to the outside through the opening 14. The reversal key 22a of the cell phone 10 is depressed to reverse the relative position of the image displayed on the display panel 32, when compared with the state for normal use. Furthermore, the audio output terminal 26 of the cell phone 10 and the audio input terminal 84 of the projector 80 are connected by a cable 94.

Subsequently, the cover 88 is removed from the housing 82 of the projector 80 to open the loading slot 87. In this state, that part of the cell phone 10 around the display panel 16 is inserted into the loading slot 87. In doing this, the body of the cell phone 10 is inserted substantially lying on its one side face so that the backlight unit 18 extends upward from the housing 82 of the projector 80. Thus, the cell phone 10 is held in the loading slot 87 of the projector 80. In the housing 82 of the projector 80, the liquid crystal display panel 32 of the cell phone 10 is located across the optical axis of the optical system at right angles to it.

Then, the light source section 89 of the projector 80 is actuated to emit illumination light. The illumination light emitted from the light source section 89 passes through the ultraviolet and infrared radiation cut filter 90, fly-eye lens 91, and PS separation-synthesis section 92 and lands on the liquid crystal display panel 32 of the cell phone 10. When this is done, the backlight unit 18 of the cell phone 10 is moved to the open position, so that the back side of the display panel 32 is opened through the opening 14. Therefore, the illumination light can land on the display panel 32 without being intercepted by the backlight unit 18. After it is transmitted through the display panel 32, the illumination light is converged by the converging lens 93 and projected onto an external screen, wall surface, or the like through the projection lens 85. A voice or sound that is outputted from the cell phone 10 is delivered through the projector 80 to an amplifier (not shown) and the speaker and reproduced thereby. Thus, the image displayed on the display panel 32 is enlarged when it is projected on the screen, wall surface, or the like, so that a large number of people can watch it simultaneously.

The light source section 89 of the projector 80 has a large enough amount of light, and the optical system including the projection lens 85 has an aperture diameter and a magnification that are also large or high enough. Since the liquid crystal display panel 32 is capable of high-precision image display, moreover, a high-resolution image with satisfactory luminance can be displayed even if the image is enlarged with a desired magnification factor, and it can be observed by a number of people at a time. The projector 80 itself may be provided with a speaker for audio reproduction without using any separately provided speaker.

Thus, if only one user uses the cell phone 10 according to the present embodiment, the user can make a call or perform electronic mail transmission-reception, image display, and movie display in the same manner as in the case of using a conventional cell phone. If the cell phone 10 is combined with the projector 80, moreover, a large number of people can simultaneously observe an image displayed on the display panel 16. Thus, the range of application of the cell phone 10 can be further widened, and the cell phone can be used more effectively. According to the display system, moreover, the display panel 16 of the cell phone 10 can be used to display a high-precision image that is enlarged with a desired magnification factor and has satisfactory luminance, and the image can be watched by a large number of people at a time.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

For example, the invention is not limited to the cell phone of the foregoing embodiment but may be also applied to a cell phone in which a display panel and a set of numeric keys and control keys are provided on two separate bodies that are connected to each other in a foldable, slidable, or rockable manner. In the foregoing embodiment, moreover, the backlight unit is located for movement in the transverse direction of the body so as to extend sideways from the body. Alternatively, however, the backlight unit may be located for movement in the longitudinal direction of the body or for movement toward the back side of the control keys. The light source for the backlight unit is not limited to LEDs but may be formed of a cold-cathode tube.

The display panel portion of the cell phone is configured to be inserted into the loading slot of the projector. Alternatively, however, the whole cell phone may be configured for loading. This invention is not limited to cell phones but may be also applied to any other portable electronic devices, such as mobile terminals, PDAs, etc.

What is claimed is:

1. A portable electronic device comprising:
a body having an opening;
a display panel which closes the opening and displays an image; and
a backlight unit movable between a display position in which the backlight unit faces the display panel in the body, is situated closing the opening and applies illumination light to the display panel and an open position in which the backlight unit is situated off the opening and allows a back side of the display panel to open.

2. A portable electronic device according to claim 1, wherein the backlight unit has a light guide plate, a light source located at a side face of the light guide plate, and a support frame which supports the light guide plate, and the body has a guide portion which engages the support frame of the backlight unit and guides the backlight unit in movement.

3. A portable electronic device according to claim 2, wherein the support frame supports the light source and the backlight unit has a power terminal provided on the support frame and connected electrically to the light source, the body has a connection terminal, which conducts with the power terminal when the backlight unit is moved to the display position and leaves the power terminal when the backlight unit is moved to the open position, and a power source connected to the connecting terminal.

4. A portable electronic device according to claim 1, which further comprises a plurality of control keys provided on the body, the control keys including a reversal key which reverses the relative position of an image displayed on the display panel.

5. A portable electronic device according to claim 1, wherein the display panel is formed of a liquid crystal display panel.

6. A display system comprising:
a portable electronic device comprising a body having an opening, a display panel which closes the opening and displays an image, and a backlight unit movable between a display position in which the backlight unit faces the display panel in the body, is situated closing the opening and applies illumination light to the display panel and an open position in which the backlight unit is situated off the opening and allows a back side of the display panel to open; and
a projector comprising a housing having a loading slot into which at least the display panel of the portable electronic device is insertable, a light source section located in the housing, and an optical system which is located in the housing and diffuses and outwardly radiates illumination light applied from the light source section, the portable electronic device being configured to be loaded into the loading slot with the backlight unit moved to the open position, the display panel being located across an optical axis of the optical system at right angles thereto.

7. A display system according to claim 6, wherein the backlight unit of the portable electronic device has a light guide plate, a light source located opposite a side face of the light guide plate, and a support frame which supports a peripheral edge portion of the light guide plate and the light source, and the body has a guide portion which engages the support frame of the backlight unit and guides the backlight unit in movement.

8. A display system according to claim 7, wherein the backlight unit of the portable electronic device has a power terminal provided on the support frame and connected electrically to the light source, the body has a connection terminal, which conducts with the power terminal when the backlight unit is moved to the display position and leaves the power terminal when the backlight unit is moved to the open position, and a power source connected to the connecting terminal.

9. A display system according to claim 6, wherein the portable electronic device comprises a plurality of control keys provided on the body, the control keys including a reversal key which reverses the relative position of an image displayed on the display panel.

10. A display system according to claim 6, wherein the optical system of the projector includes a projection lens provided exposed on an outer surface of the housing, an ultraviolet-infrared cut filter and a lens provided between the light source section and the loading slot, and a converging lens provided between the loading slot and the projection lens.

11. A display system according to claim 6, wherein the portable electronic device has an audio output terminal provided on the body, and the projector has an audio input terminal provided on the housing and connectable to the audio output terminal.
